(19) United States
(12) Patent Application Publication
(10) Pub. No.: US 2023/0419402 A1
(43) Pub. Date: Dec. 28, 2023

(54) SYSTEMS AND METHODS OF OPTIMIZING MACHINE LEARNING MODELS FOR AUTOMATED ANOMALY DETECTION

(71) Applicant: THE TORONTO-DOMINION BANK, Toronto (CA)

(72) Inventors: MAHDI GHELICHI, TORONTO (CA); ANDRES FELIPE MASMELA, OAKVILLE (CA); ZOLTAN HERING, TORONTO (CA); ZIZHUANG TANG, RICHMOND HILL (CA); ZHIYI CHEN, TORONTO (CA)

(21) Appl. No.: 17/847,992

(22) Filed: Jun. 23, 2022

(51) Int. Cl. G06Q 40/02; G06K 9/62

(52) U.S. Cl. CPC G06Q 40/025; G06N 20/20; G06K 9/6282

(57) ABSTRACT

There is provided methods, systems and techniques for optimized anomaly prediction using machine learning. A data set is obtained which corresponds to a query for anomaly detection. Feature classification is performed along with anomaly labelling using an unsupervised clustering technique based on determining similar groups of data and behaviours and determining a distribution for a particular feature of interest in each cluster such as to apply a threshold to each cluster to extract the anomaly data and label same. Once the labelled dataset is generated, a tree classification model is trained based on the labelled data set for detecting anomaly. Once trained, a set of computing model rules may be extracted from the tree classification model to generate a rules executable for anomaly spotting to define combinations of feature characteristics resulting in outlier data so that the rules executable may be applied to new data.

### FIELD

The present disclosure relates to systems, methods and techniques for automated anomaly detection and particularly to optimizing machine learning models for such detection.

### BACKGROUND

Data under-reporting or over-reporting, such as customer input data provided during submitting an application to a computing device for a new customer account or during data transactions or other electronic communications between computing systems including account data, presents a significant challenge for entity computing systems to accurately detect, flag, understand, and/or pre-emptively predict. Additionally, even if transaction data may be flagged, there is no mechanism for explaining and verifying such flagging in real-time. Detecting anomalies in data communicated between entities provided as part of a submission to an entity computing device preferably needs to occur dynamically, in real-time and be readily verifiable as well as have reproducible results so that it can be relied upon and actions taken (e.g. deactivating or flagging communications or updating subsequent flagging).

For example, manual identification of anomalies in self-reported or customer provided transaction data, e.g. customer income, is exceedingly difficult. As an example, as large amounts of transaction data are communicated between computing devices it becomes unfeasible and inaccurate to manually predict and/or identify anomalies in the input data. An additional hurdle is that manual identification does not allow clear determination of data patterns or communication patterns leading to such anomalies and thus either the data patterns are not flagged in time and/or they are inconsistently applied as the large amounts of data and/or features of such data (e.g. as communicated for account data) are impossible for manual analysis and interpretation.

It is desirable to have a computing system, method and device to address at least some of the shortcomings of existing systems.

### SUMMARY

In one aspect, it would be helpful to provide a system, method, device and technique to proactively, and effectively identify transaction data anomalies for further verification and deployment.

It is generally difficult to provide computing models for proactively flagging outlier or anomaly transaction data in an efficient and reproducible manner which can be interpreted and verified. Additionally, utilizing supervised machine learning models alone may be resource intensive and unrealistic as it relies upon manual labelling of a training data set and can be difficult to deploy (as well as virtually impossible as the amount of data grows). This can also lead to inaccuracies as it is dependent upon the accuracy of the manual labelling in the training data. On the other hand, utilizing unsupervised machine learning models alone for anomaly detection may be ineffective as it does not allow verification of the model and explanation of the rules generated for anomaly prediction.

In at least some aspects, there is an optimized machine learning system, device, technique and method that determines outliers or anomalies of a particular type or attribute of data within a larger set of data (e.g. self-reported income to identify individual's likely over-reporting or under-reporting income) such as in account data for a number of customer accounts, using a combination of different machine learning models utilizing both unsupervised and supervised models configured to cooperate to leverage benefits of each model type configured in a particular manner as described herein to generate a computer implementable executable including a set of model rules which are easily deployable for subsequent anomaly detection and verification of the model operation. In at least some aspects, this provides an advantageous and optimized machine learning model architecture which does not rely on manual training of the data and provides automated reasoning generation for the prediction(s).

In at least some aspects, the combination of machine learning models includes a first unsupervised clustering classification model for grouping the account data based on similar features to mark certain data within each cluster as anomalies based on the distribution of values for the particular type of data indicating that it exceeds a threshold for that cluster and a second tree classification model utilizing supervised learning for receiving the marked data and extracting machine learning based model rules (e.g. rules for one or more of the features of the data and associated parameters for the features linking to normal or anomaly detection) including feature characteristics of the data points in the account data and an associated likelihood of anomaly for that particular type of data.

In at least some aspects, the first clustering model may utilize an unsupervised machine-learning model to identify customer income anomalies without the need for a training data set previously labelled and classified based on income anomalies, or lack thereof. In at least some aspects, the second machine learning model (e.g. a single tree classification model) will utilize a supervised machine-learning model (based on receiving labelled data from the first model indicating anomaly or not) to identify common feature variables or attributes of the input data and segmentation parameters to allow for the future development of rule sets for particular feature value verification, e.g. income, to allow for the identification of customer income anomalies in additional sets of data including portfolios.

In at least one aspect, there is provided computational methods, systems and techniques configured to automatically assess one or more characteristics of real-time or near real-time data using an unsupervised machine learning model to determine similarities, generate labelled data and anomaly predictions for training a supervised model for anomaly detection and deployment.

In one aspect, there is provided a computerized machine learning system for detecting anomalies in account data, comprising: an unsupervised clustering module configured to receive unlabeled account data sets comprising data points with corresponding feature values for defined input features as training data, the clustering module clustering the account data sets into a set of clusters based on similarities between the feature values for the input features within each cluster being more than across other clusters; an anomaly detection module coupled to the unsupervised clustering module configured to: receive the set of clusters and corresponding account data sets contained within each of the clusters; determine, for each of the clusters, a distribution pattern of the feature values in the account data sets, corresponding to a plurality of accounts, for a particular feature defined as being associated with detecting anomalies and based on the distribution pattern, determine a percentile threshold value above which anomalies occur for the particular feature and label the data points in each of the account data sets for each cluster having the feature values for the particular feature exceeding the percentile threshold value with anomaly metadata indicative of anomaly and others as normal to generate labelled data sets with the anomaly metadata; and, a single tree classification model coupled to the anomaly detection module for receiving the labelled data sets and mapping the feature values for the input features in the account data sets onto the tree classification model and extracting a set of rules from the tree classification model for generating a rules executable for subsequent classification of anomaly, the rules comprising a set of different combinations of identified features from the input features and corresponding value ranges associated with a likelihood of anomaly for the particular feature.

In another aspect, the single tree classification model is configured to classify new customer data having the input features and apply the set of rules to the feature values of the new customer data to determine a classification of whether the new customer data is outlier income or normal and sending the classification to a graphical user interface for display thereof.

In another aspect, subsequent to the clustering forming the clusters, the anomaly detection module is configured for labelling each abnormal high normal account in a given cluster with a binary value 1 and labelling each normal account with a different binary value 0 for being fed into the single tree classification model as the labelled data sets for subsequent rule extraction thereof.

In another aspect, the tree classification model is a light gradient boosted model.

In another aspect, identifying particular data points having outlier incomes in each cluster comprises, determining from the distribution pattern for each said cluster, a deviation amount from a median of the distribution pattern which corresponds to a defined percentile occurrence of the particular feature for the account data sets, determining that particular data points having a degree of deviation exceeding the deviation amount thereby indicating anomaly as compared to other data points within that cluster.

In another aspect, mapping the feature values onto the tree classification model further comprises grouping the feature values for the input features into broader category of features based on commonalities between the input features and the extracted set of rules generated as having the broader category of features and associated value ranges for categorization into the likelihood of anomaly.

In another aspect, the defined input features is selected from the group: debt history, mortgage amounts, mortgage payments, utilization ratio and credit limits associated with accounts of one or more customers.

In another aspect, the tree classification model receives historical customer data and current customer data for the account data sets relating to the broader category of features comprising: mortgage attributes, debt history, and financial capacity of one or more customers for generating the tree classification model.

In yet another aspect, the single tree classification model is configured to extract the set of rules by: utilizing the historical customer data and the current customer data applied to the single tree classification model to identify features and segmentation parameters for the value ranges associated with a likelihood of anomaly.

In yet another aspect, the single tree classification model is applied to an output of the anomaly detection module comprising the labelled data sets for characterizing the rules for generating the labelled data sets based on a second set of features comprising the broader category of features for the labelled data sets, the second set of features extracted by the single tree classification model having been trained on historical customer data as related to the particular feature.

In yet another aspect, there is provided a method of using machine learning models for anomaly detection in a set of accounts, the method comprising: clustering training data comprising account information into a set of clusters, via a clustering model, based on input features for the accounts by: receiving the training data comprising data points defining each feature of the input features for each account in the set of accounts held by an entity, the training data comprising historical data characterizing each said account in terms of the input features for the accounts, each cluster clustering similar accounts having similarities between one or more associated features in the data points; determining, for each of the clusters, a particular feature distribution pattern for accounts contained therein including a median and a degree of deviation, the particular feature defined as related to the anomaly detection; identifying particular data points within each cluster having outlier data based on the particular feature distribution for that cluster and labelling each data point within each cluster as to whether outlier or normal and forming an updated training data set comprising the labelling; training a tree classification model based on the updated training data set being labelled for detecting anomaly; extracting rules from the tree classification model to generate a rules executable for anomaly spotting, the tree classification model being trained to define combinations of feature characteristics resulting in outlier data; and, applying the rules executable to new customer data having said feature characteristics to determine a classification of whether outlier or normal.

In yet another aspect, identifying the particular data points having outlier incomes in each cluster comprises, receiving a defined deviation threshold for each said cluster and determining that the particular data points in that cluster have a particular degree of deviation exceeding the defined deviation threshold thereby indicative of anomaly as compared to other data points within that cluster.

In yet another aspect, subsequent to the clustering forming the cluster, the labelling further comprising: labelling each abnormal high normal account in a given cluster with a binary value 1 and labelling each normal account with a different binary value 0 for being fed into the tree classification model.

In yet another aspect, the tree classification model is a supervised model and the clustering model is an unsupervised model structurally linked to extract the rules therefrom.

In yet another aspect, the tree classification model is a light gradient boosted model.

In yet another aspect, the data points define features comprising: self-reported income and earnings; customer credit attributes data, and customer profile data comprising historical spending patterns and behaviours.

In yet another aspect, the customer credit attributes data comprises debt history, mortgage amounts, mortgage payments, and mortgage credit limits of one or more customers.

In yet another aspect, extracting rules from the tree classification model further comprises: utilizing historical customer data and current customer data applied to the tree classification model to identify feature variables and segmentation parameters associated with a likelihood of anomaly.

In yet another aspect, the historical customer data and current customer data is characterized by defining: mortgage attributes, debt history, and financial capacity of one or more customers for generating the tree classification model.

In yet another aspect, applying the labelled data sets to the tree classification model for characterizing the rules for generating the labelled data sets based on a second set of features defining a tree structure for the tree classification model, the second set of features extracted by the single tree classification model having been trained on historical customer data as related to the particular feature.

These and other aspects will be apparent to those of ordinary skill in the art.

### BRIEF DESCRIPTION OF THE DRAWINGS

These and other features will become more apparent from the following description in which reference is made to the appended drawings wherein:

FIG. 1 is a block diagram of an example computing environment including an outlier detection system using machine learning for automated anomaly detection, according to an example embodiment;

FIG. 2 is a block diagram of an example computer system, such as an outlier detection system of FIG. 1, that may be used to perform automated anomaly detection using machine learning, according to an example embodiment;

FIG. 3A is a block diagram of an example method of proactive anomaly detection using machine learning models (e.g. of FIGS. 1 and 2) for optimizing machine learning models for anomaly detection, according to an example embodiment;

FIG. 3B is a graph of an example probability distribution for a particular feature of interest within received input data for the anomaly detection (e.g. income distribution) according to various determined clusters as may be generated from clustering models of FIGS. 1 and 2, according to an example embodiment;

FIG. 3C is an example flow chart depicting a raw computer model output for rules from the rule extraction module of FIGS. 1-2 of determined relationships between features (and feature characteristics) and a likelihood of anomaly in a particular selected feature of interest (e.g. income attributes), according to an example embodiment;

FIG. 3D is an example flow chart depicting a set of model rules configured for generating a rules executable as provided by the rule extraction module of FIGS. 1-2 for anomaly detection, according to an example embodiment; and,

FIG. 4 is an example flow chart for applying machine learning models for automated anomaly detection and deployment (e.g. utilizing optimized system of FIGS. 1-3A), according to an example embodiment.

### DETAILED DESCRIPTION

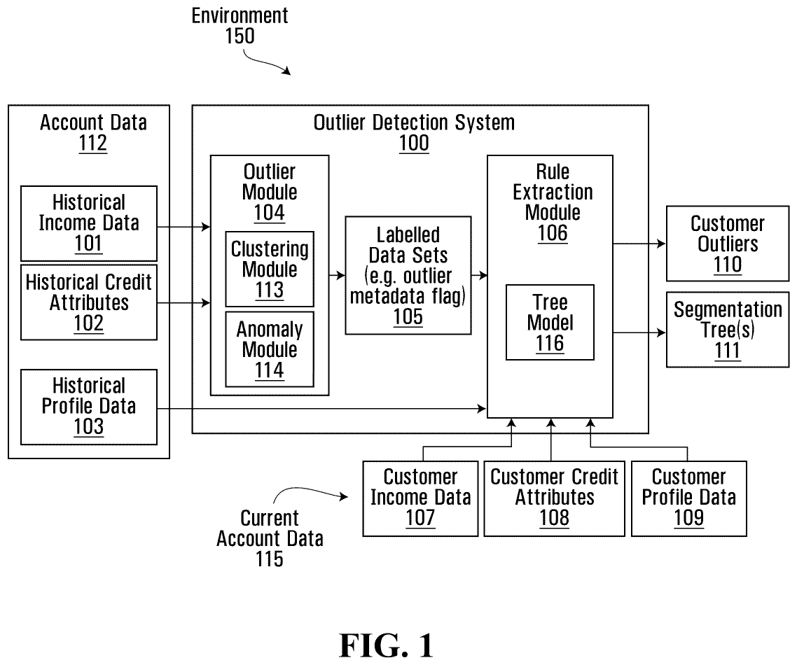

In at least some aspects, there is proposed an optimized machine learning system, technique, method and architecture which utilizes a particular combination and structure of an unsupervised machine learning model (e.g. hierarchical clustering model) and a supervised machine learning model (e.g. a single tree classification model) coupled together in a specific order to utilize advantages of each of the models and yield an optimized and improved computing model for income anomaly detection and prediction which is conveniently deployable and explainable (see example computing environment shown in FIG. 1).

Preferably, in at least some implementations, the combination of the two machine learning models according to the present disclosure leads to supervised learning guided rule extraction which allows the dynamic generation of a set of model rules which may be applied to new transaction data for subsequent detection and flagging of anomalies. Additionally, in at least some aspects, the proposed system conveniently generates the set of model rules (e.g. which features and/or different combination of features of the input transaction data and what parameters for the features leads to anomalies/normal data) thereby to allow clear visibility and verification of information indicating under which data feature conditions (e.g. particular flow of data features or flow of data communications) leads to a high likelihood of anomaly or normal.

If supervised machine learning models in a stand-alone system were applied to identify income anomalies, this may lead to certain disadvantages such as requiring the manual identification, analysis and labelling of input training data for anomaly detection (e.g. income data as an outlier or not outlier). This supervised system alone may be a time consuming and unfeasible process which can lead to inaccuracies. That is, using a standalone supervised-machine learning model would require manually defining and forming the training set which would include manual classification and labelling of data. For example, in order to classify input data to determine whether an anomaly of a particular feature type of data may occur (e.g. customer income anomaly), each input data used for training would be manually defined as falling within the anomaly or non-anomaly data for that particular feature in order to develop a training dataset for the model. This stand-alone supervised model for anomaly detection may be a manual and resource intensive process and not feasible as the data and number of features grows.

If unsupervised machine-learning models alone were used to identify and label a particular data feature, such as income data within account data as outliers and/or anomalies, they would lead to other disadvantages such as being a “black box” approach and thereby not providing an explanation for the results or rule sets for which a determination of anomaly classification is made for new data sets. Put another way, once an output is generated for new unseen data as to whether the data features fall within anomaly or not classification, the standalone unsupervised model would provide no explanation as to the reasoning of why the output falls within a classification and how that determination is made (e.g. the features of the data which lead to the anomaly determination or not are hidden). Since no insights would be provided as to how a determination of anomaly or not is reached, this may also prevent verification of how the determination is reached. Using a standalone “black box” model to prediction of anomalies in the data may lead to inability to reproduce or explain the results. Additionally, in at least some examples, such standalone models would be difficult to implement for detection and prediction because it may be unclear why or how they flag transaction data as anomalies or not for follow up verification (e.g. they lack information as to why data was marked as an anomaly and how or when should subsequent data be marked as such).

In accordance with at least one embodiment of the present disclosure, by combining supervised and unsupervised machine-learning models for automated anomaly detection such as to leverage the advantages of machine learning, the disclosed system architecture, method and technique may identify customer income anomalies without the need for the prior labelling of a training dataset, whilst additionally automatically analyzing the labelled data to identify variables and segmentation parameters associated with the likelihood of income anomalies such as to generate a rules executable for subsequent deployment of anomaly prediction.

FIG. 1 illustrates an example machine learning architecture and computing environment 150 for anomaly detection, in accordance with one embodiment. A feature outlier detection system 100 is a computing system (e.g. computing device or server) which comprises an outlier module 104 and a rule extraction module 106 for performing the automated anomaly detection and to generate a rules executable for subsequent automated anomaly detection. The outlier detection system 100 may receive an input of account related data sets, such as account data 112, which may include transaction related account information data and values or characteristics of features for the data for a plurality of customer accounts and/or customer interactions (e.g. via transactions or via computing requests with the outlier detection system 100 such as requests received for modification of accounts), the customer account held within one or more entity servers (not shown for simplicity of illustration). The account data 112 may include both user provided data (e.g. user input income information which may be manually provided such as during submitting an application for a particular service from the entity) and/or transaction data (e.g. information automatically derived by one or more data processing servers for the entity and in network communication with the outlier detection system 100, the data processing servers and network not shown for simplicity of drawings). The transaction data obtained in the account data 112 may be received from a number of sources, e.g. automatically generated to capture transaction information for customer computing devices relating to accounts and/or communications between a customer computing device and one or more entity data processing servers containing the accounts (e.g. transaction to pay a bill and move financial data from one data source to a data sink device; or transaction to open a new account; transaction to request a new service; transaction to move money between accounts, etc.). The customer computing devices, the entity data servers and the networked environment are not shown for simplicity of the illustration but may be example sources of information for the account data 112.

It is understood that the environment 150 and/or system 100 may include additional computing modules, processors and/or data stores in various embodiments not shown in FIG. 1 to avoid undue complexity of the description. It is understood that FIG. 1 is a simplified illustration. Additionally, the system 100 may communicate with one or more networked computing devices to obtain information and data for generating the machine learning models in the outlier module 104 and/or the rule extraction module 106 and for example, to provide the generated rules executable for subsequent deployment to other computing devices.

Referring again to FIG. 1, the account data 112 may comprise historical customer data which includes a number of customer accounts and characteristics (e.g. values or ranges of values or other descriptors) of features of interest for those accounts monitored and gathered for a defined past period of time. For example, the historical customer data may include customer transaction metadata when interacting with the outlier detection system 100. The account data 112 may include historical income data 101, historical credit attributes 102, historical profile data 103) and current account data 115 may include current customer data for transactions and accounts held within one or more computing devices of an entity such as but not limited to: customer income data 107, customer credit attributes 108, customer profile data 109), and in at least some aspects associated with self-reported or provided customer data related to a particular feature of interest (e.g. income attribute) for which a likelihood of anomaly is to be automatically detected, e.g. customer provided income metadata provided to a customer computing device and communicated to the outlier detection system 100. Although, the present examples illustrate income anomaly detection, the outlier detection system 100 may be configured to automatically detect anomalies relating to any of the defined features of interest in the input data and to extract executable model rules therefrom for guided rule extraction and further understanding as well as verification of the machine learning model anomaly detection provided by the outlier detection system 100.

In the example where income is a desired feature of interest for anomaly detection (e.g. as may be defined in the outlier module 104), the account data 112 and current account data 115 which comprises historical income data 101 and customer income data 107 further comprises customer income data (e.g. self-reported income and earnings) of historical and current customers respectively. Historical credit attributes 102 and customer credit attributes 108 comprises customer credit data (e.g. debt, mortgage amounts, mortgage payments, mortgage credit limits) of historical and current customers respectively as related to the desired feature of interest for anomaly detection. Historical profile data 103 and customer profile data 109 comprises additional profile data for accounts held within the account data 112 and current account data 115 including customer online transaction behaviors for the accounts (e.g. credit card limits, previous spending patterns, previous mortgage payment patterns, previous income patterns, credit history) of historical and current customers respectively.

Outlier module 104 implements an unsupervised machine-learning clustering algorithm (via clustering module 113), configured to receive account data 112, including historical income data 101 and historical credit attributes 102, to identify and label historical outlier anomalies based on one or more features of interest processed for anomaly such as reported income (labelled data sets 105 for depicting outlier metadata flag).

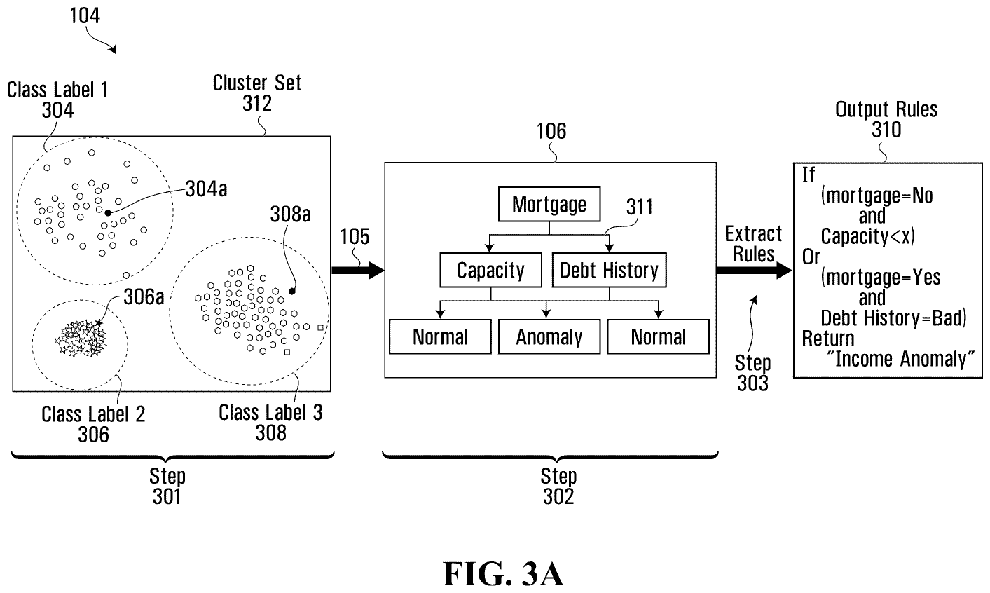

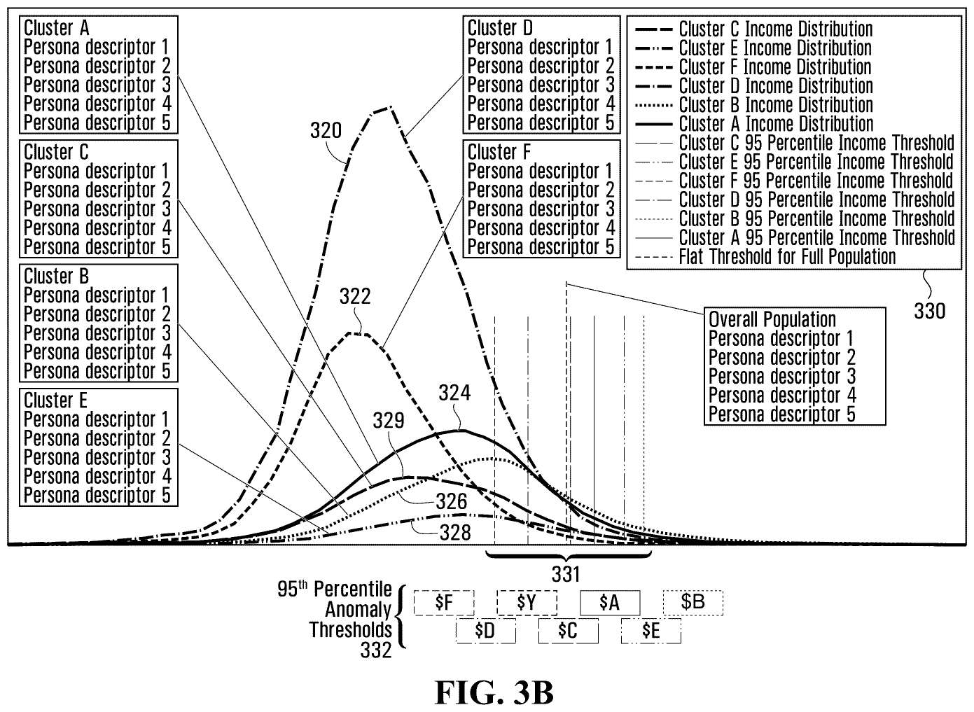

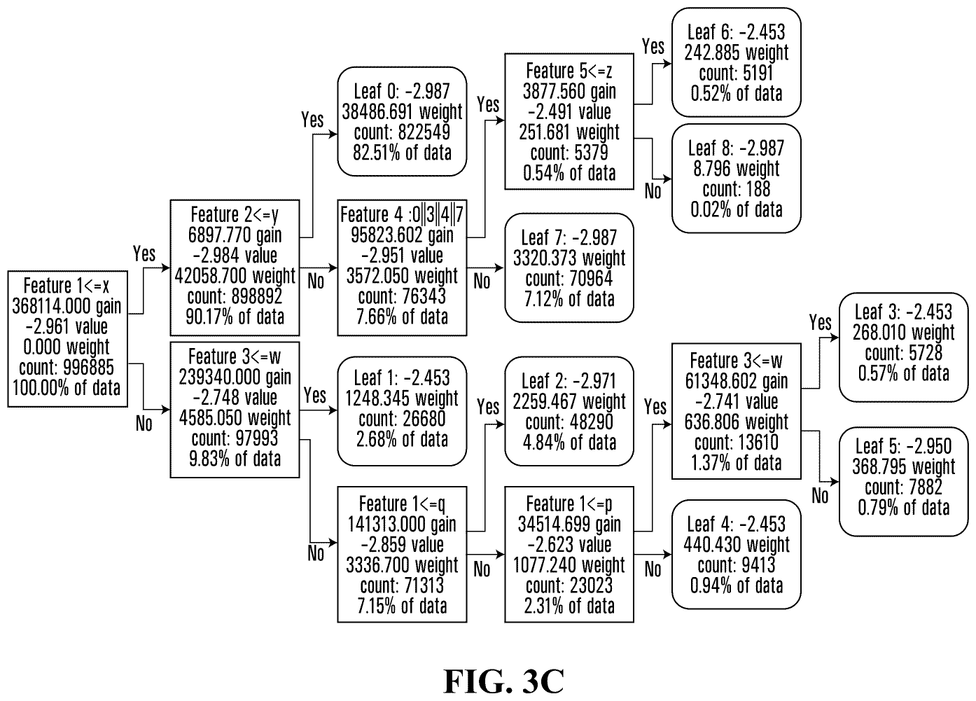

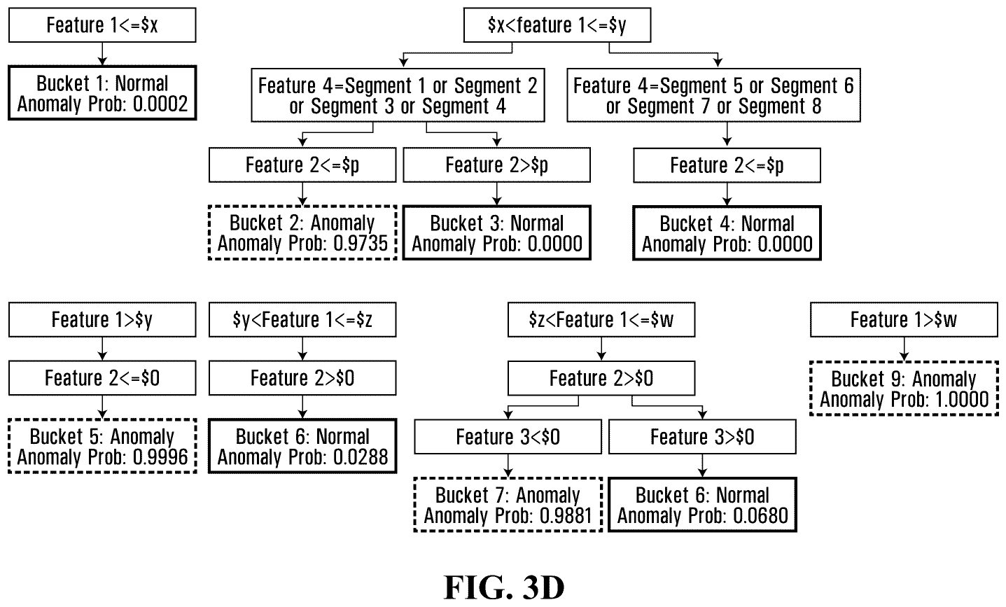

Preferably, the clustering module 113 implements a density-based clustering algorithm such as DBSCAN although other types of clustering methods including k-means clustering may be applied in other embodiments. Referring to FIGS. 1, 2 and 3A, in at least one embodiment, the clustering module 113 implements a density-based clustering algorithm which does not require specifying the number of clusters to use it, rather, a defined threshold is set, received or dynamically defined based on prior iterations of the model as to an amount of similarity distance to consider two data points as being similar to one another. Additionally, in at least some aspects, the density based clustering as may be provided by the clustering module 113 conveniently allows understanding of a variety of different distributions of the input data in the account data 112 thereby allowing more effective and reasonable results in the clusters, e.g. cluster set 312. Further conveniently, this unsupervised clustering technique allows understanding and analysis of different types of data and distributions to provide better and more accurate clustering regardless of the distribution of data as the distribution of data will be further analyzed as will be discussed with reference to FIG. 3B for anomaly threshold detection to be fed to a rule extraction module 106. In some aspects, the clustering provided by the clustering module 113 may be a hierarchical DBSCAN which provides effective separation of clusters for a variety of distributions using unsupervised clustering.

Thus, the outlier module 104 is configured to receive unlabeled and unclassified data as described herein (e.g. income data, credit data and/or customer profile data relating to one or more accounts and transactional activity related thereto such as online behaviours for opening and interacting with accounts) and may have no prior knowledge of anomalies in the received data for a particular feature of interest for anomaly detection (e.g. income data). The outlier module 104 additionally processes the data received to perform clustering of the data based on commonality of the feature values contained therein (e.g. income, credit, profile, etc.) and for each of the generated clusters (e.g. see also example cluster set 312 in FIG. 3A) constructs and determines a distribution pattern for the data values or data ranges (or other characteristics) of the feature of interest. An example distribution pattern or function for a feature value of interest for an example cluster set such as the cluster set 312 in FIG. 3A is constructed and shown at FIG. 3B, with each cluster having a corresponding distribution for a particular feature for each of the points in the cluster and a higher amplitude indicative of a higher occurrence or likelihood of a given value occurring for that feature of interest with the given cluster. In at least some aspects, the anomaly module 114 is then configured to process the distribution of values for the particular feature of interest (e.g. a first distribution 320, a second distribution 322, a third distribution 324, a fourth distribution 326, a fifth distribution 328, a sixth distribution 329 shown in FIG. 3B as examples for corresponding clusters) within each of the clusters generated by the clustering module 113 and applies a distribution threshold (e.g. example distribution threshold range 330) to each distribution graph for each cluster, the distribution threshold may be dynamically defined based on the generated distribution graph, such that the data points within each cluster having a value above the distribution threshold may be defined as a higher likelihood of anomaly and labelled as such within the labeled data sets 105 while other data points within the account data 112 as processed in the clusters provided by the clustering module 113 and having values for the feature of interest below the distribution threshold as further processed by the anomaly module 114 may be labelled as normal.

Thus, the labelled data sets 105 may contain the account data 112 as well as additional information derived from the clustering module 113 and/or anomaly module 114 including having been labelled with outlier or normal metadata as a result of processing by the clustering module 113 and the anomaly module 114. Rule extraction module 106 implements a supervised machine-learning model (via a tree model 116) trained on labelled data sets 105 provided by the outlier module 104, which includes the account data input being labelled and including metadata as to whether outlier or normal for a predefined feature of interest selected for anomaly prediction (e.g. in some aspects, with a likelihood of anomaly for the particular feature for assessing anomalies). In some aspects, the feature of interest for which the anomaly is predicted based on a behaviour pattern in its specific cluster and flagged accordingly is income data within the account data as compared to other data within each cluster defined by a clustering module 113 which feeds to an anomaly module 114 to detect the presence of outlier data for the feature of interest within each cluster. Outlier metadata provided in the labelled data sets 105 and historical profile data 103, may be provided to the rule extraction module 106 to identify current customer income outliers (e.g. customer outliers 110) based on current customer data provided in current account data 115 (e.g. having a number of features or attributes, including: customer income data 107, customer credit attributes 108, customer profile data 109), such customer outliers 110 may represent current customers likely under-reporting or over-reporting income as input data within an application or communicated across other transactions.

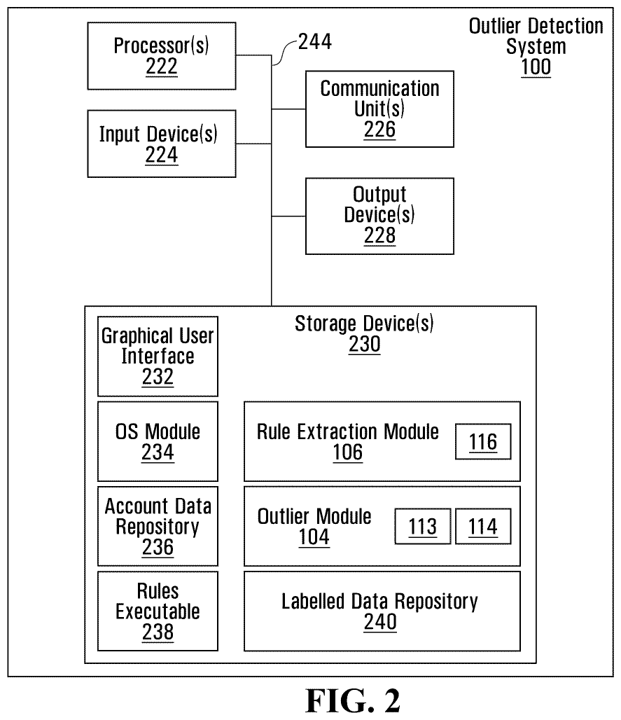

In the example embodiment shown in FIG. 1, the outlier module 104 generally is configured to generate labelled data indicative of a likelihood of anomaly in the data for a feature of interest from unsupervised clustering machine learning models by applying a dynamic threshold to a constructed distribution pattern for a particular feature in the data within each cluster. The rule extraction module 106 is generally configured to utilize the labelled data sets to extract additional feature data from each of the account (e.g. historical profile data 103) and train a single tree classification model to generate a decision tree classifier to create explainable machine-learning based rules for anomaly detection for the feature of interest, e.g. income anomaly detection based on extracted rules from the tree model. Such rules may be used to explain and verify the tree model 116 once trained and generating a rules executable (e.g. rules executable 238 in FIG. 2) from the rules derived from the generated model such that the rules executable is used for subsequent anomaly detection.

The machine-learning model implemented in the rule extraction module 106 comprises a single tree based classification model, such as a light gradient boosting machine model (LightGBM) shown as a tree model 116 configured and trained based on the received labelled (e.g. labelled data set 105) dataset to classify in its tree whether the features of the input data, once processed are likely to indicate normal or anomaly and the conditions under which the features or the set of features in the input data would be likely to lead to a determination of anomaly or normal.

Specifically, the tree model 116 is trained using the labelled data sets 105 provided as input as well as additionally derived features obtained from the historical profile data 103 to generate a set of rules including one of more features and corresponding parameters for the features used to detect a likelihood of anomaly or not in the input data for a particular feature. Thus, the tree model 116 once trained additionally identifies attribute variables and segmentation parameters, such as segmentation trees 111 (an example of such segmentation trees is shown at step 302 in FIG. 3A and output rules 310 of FIG. 3A providing a textual representation of the rules in the segmentation trees). Such attribute variables and segmentation trees 111 may be associated with a data feature of interest, e.g. income, based on current and historical customer data (e.g. customer income data 107, customer credit attributes 108, customer profile data 109, historical profile data 103), which may be used to further aid in the identification of current customer income anomalies (e.g. as shown in customer outliers 110).

In at least some aspects, the set of rules provided in the segmentation trees 111 and/or the customer outliers 110 as provided by the outlier detection system 100 are presented and/or deployed on a requesting computer device (not shown) which may be networked to the outlier detection system 100 for subsequent use thereof.

Referring to FIGS. 1 and 3A, in FIG. 3A shown is an example flow of operations and implementation of example components of the outlier detection system 100 of FIGS. 1 and 2. At step 301, training data input into the outlier module 104, and specifically, the clustering module 113, is clustered into a set of clusters based on calculating a similarity distance between features of data points and grouping together similar data points (e.g. a first cluster 304 having a class label 1, a second cluster 306 having a class label 2, and a third cluster 308 having a class label 3) based on input features provided to the clustering process. Within each of the determined clusters in a cluster set 312 that is constructed, abnormal data points are identified based on a cluster distribution for a particular feature of interest (e.g. abnormal high income accounts).

An example of probability distribution functions depicting a pattern of occurrence and associated values for a particular feature of interest is shown in FIG. 3B for each of the clusters. By constructing a distribution (e.g. probability distribution function for the feature within each of the clusters as shown in FIG. 3B), a cut-off threshold is dynamically determined. For example, in FIG. 3B, for each cluster of the clusters A-F and associated distribution for the particular feature (e.g. income distribution), a defined percentile anomaly threshold, e.g. a 95th percentile income threshold is determined. In some aspects, the outlier module 104 and specifically, the anomaly module 114, is configured to then define an average or overall threshold 331 for all populations as based on the average of the threshold for each of the clusters.

Notably, in the first cluster 304, a particular data point within the cluster is detected as being abnormal in terms of the feature values for one or more features of interest based on the constructed distribution and the threshold for the cluster as dynamically configured. For example, a first abnormal data point 304a is detected based on determining that the feature value for that particular feature of interest exceeds an anomaly threshold. Similarly, in the second cluster 306, a second abnormal data point 306a is detected and in the third cluster 308, a third abnormal data point 308a is detected and labelled accordingly. The remaining data points within each cluster at step 301 are assigned a “normal” label while the outlier data points exceeding the anomaly threshold (e.g. see FIG. 3B) are labelled as “outlier” or “anomaly” as examples and the collection of such labelled data from the cluster set 312 forms the labelled data set 105 provided at step 301 to step 302 (e.g. from the outlier module 104 to the rule extraction module 106).

For example, the anomaly module 114 may configured for labelling each abnormal high normal account in a given cluster with a binary value 1 and labelling each normal account with a different binary value 0 for being fed into the single tree classification model, e.g. the tree model 116, as the labelled data sets for subsequent rule extraction thereof.

Referring to FIGS. 1 and 3A, the outlier module 104 comprises a clustering module which is configured to group customers of similar behavior together, in at least one aspect. Each of the clusters (e.g. cluster set 312) may have quite a distinct distribution of feature values for the anomaly feature of interest (e.g. quite distinct distribution of income) and thus able to better label income anomalies more specific for certain types of data (e.g. belonging to a particular cluster).

In one example embodiment, the example data features tracked and collected in the account data 112 at the clustering module 113 for allowing anomaly detection and labelling based on clustering and distribution analysis include but are not limited to: utilization ratio, total debt across trade lines, credit limit on credit cards (e.g. how much debt on credit cards), credit limit on mortgage trade lines (e.g. loan on mortgage accounts), and trade mortgage payment (e.g. payment amount on mortgage on a time basis or frequency basis). The account data 112 features may be preferably derived based on dynamically being identified as having attributes or features which are directly correlated to the anomaly feature of interest (e.g. income features of the input data) in the input data based on a training set, such as a machine learning model based on tracking historical behaviours. Thus, the outlier module 104 may be additionally configured to extract one or more data features from the account data dynamically determined and historically correlated with anomaly detection for a defined feature of interest. In one example, such information may be stored within a repository in the outlier module 104 for subsequent access (e.g. account data repository 236 may contain a mapping between data features and corresponding correlated features from which anomaly detection may occur).

Referring again to FIGS. 1, 2, 3A and 3B, the features extracted by the outlier module 104 from the unlabeled account data 112 and input into the clustering module 113 and the anomaly module 114 provide the labeled data set by performing clustering thereon. Once the labelled data set 105 with the data points being flagged as to whether anomaly or normal in the metadata describing the account data (e.g. either directly or a pointer to an external database or repository containing such labelling such as within labelled data repository 240 in FIG. 2 is obtained), the rule extraction module 106 is configured, in at least some implementations to extract additional features from the input data set for each set of the input data points such as historical profile data 103 and this is input along with the labelled data sets 105 information into the tree model 116. A second operation step 302 illustrates receiving the labelled data set 105 at the rule extraction module 106 along with simultaneously extracting additional data features of interest (e.g. historical profile data 103) used to train a single tree classification model shown at the tree model 116. Example features in a generated tree model is shown in FIG. 3A, e.g. credit limit on mortgage, credit limit on credit card, capacity, debt history, income of applicant, and segmentation parameters, such as normal or anomaly. Once the tree classification model is trained at step 302 and the resulting decision tree is formed as shown at an example decision tree in FIG. 3A as a first decision tree 311, the rules from the tree model 116 may be extracted therefrom. Notably, once the single tree classification model is trained, the tree model 116 will produce a tree (e.g. a first decision tree 311) and the end node of the tree will illustrate values for the anomaly feature of interest, e.g. some nodes indicate anomaly and others are not anomalies. Based on this, the rule extraction module 106 is configured to extract rules from each tree which lead to one of the end node results including the set of particular features, associated feature characteristics and parameters. The rules may define, that based on a pattern of behaviours in the data analyzed by the rule extraction module 106, if the end node leads to a high likelihood of anomaly then the data for the customer is indicative of anomaly and if the end node leads to a low likelihood of anomaly then the data for the customer is indicative of normal data. The trained tree as shown as the first decision tree 311 is thus able to extract the rules that were embedded in step 301 and provide same as output rules 310. The output rules 310 may further be used to verify the cluster segmentations in the cluster set 312 at step 301 and determine whether the models at step 301 and step 302 are performing accurately or whether additional outliers are detected and thereby the models should be updated. In at least one implementation, the tree model 116 is a light gradient boosted machine learning, GBM model.

FIGS. 3C and 3D illustrate example output rules as provided by the rule extraction module 106 in the outlier detection system 100 of FIGS. 1, 2 and 3A and the different possible paths which may lead to anomaly or normal determination in the data along with a probability likelihood for such a determination based on historical training of the data. Notably, FIG. 3C, illustrates an example initial set of rules provided as a raw model output determined from the rule extraction module 106. Thus, the rule extraction module 106 is configured to process the raw model output and extract a set of understandable rules therefrom which illustrate feature criteria for the input data including which segment parameters the features correspond to, the anomaly segmentation and a likelihood of anomaly. FIG. 3D illustrates an example set of extracted rules for income anomaly detection as processed by the rule extraction module 106 subsequent to having a trained tree model 116. As shown in FIG. 3D, different classification buckets may be defined in the feature rule sets which includes segmentation parameters and linked to anomaly probabilities, the probabilities based on historical data used to train the tree model 116 (e.g. historical account data 112). The segments for the features shown in FIG. 3D may correspond to feature characteristics or feature values or ranges of values as extracted from the model rules (e.g. at step 302 and step 303 of FIG. 3A to extract output rules 310).

Advantageously, and in at least some implementations, the proposed computing architecture provides an optimized and improved machine learning model for computing model rules for anomaly detection, flagging and deployment. Notably, in at least some aspects, the computing model and architecture disclosed herein which combines supervised and unsupervised machine learning models as described herein, allows mapping historical input features and corresponding potential parameter values onto a set of executable computing rules for subsequent automated anomaly detection for a particular selected feature of interest thereby providing an efficient, explainable (transparent) and deployable system architecture using machine learning which dynamically identifies potential anomalies or outliers of a particular attribute or feature in a computationally efficient manner.

FIG. 2 illustrates example computer components in block schematic form of an example computing device, shown as the outlier detection system 100 to perform a method of anomaly detection using machine learning models, as described herein (e.g. with reference to the environment 150 in FIG. 1, the methods of FIG. 3A) such as to generate executable computing rules for such detection (e.g. with reference to example rules shown in FIGS. 3A, 3C and 3D) in accordance with one or more aspects of the present disclosure.

The outlier detection system 100 comprises one or more processors 222, one or more input devices 224, one or more communication units 226 and one or more output devices 228. The outlier detection system 100 also includes one or more storage devices 230 storing one or more computing modules such as a graphical user interface 232, a rule extraction module 106 comprising a tree model 116, an operating system module 234, an outlier module 104 comprising a clustering module 113, an anomaly module 114; a labelled data repository 240 and a rules executable 238.

Communication channels 244 may couple each of the components including processor(s) 222, input device(s) 224, communication unit(s) 226, output device(s) 228, display device such as graphical user interface 232, storage device(s) 230, operating system module 234, account data repository 236, rule extraction module 106, outlier module 104, labelled data repository 240 and rules executable 238 for inter-component communications, whether communicatively, physically and/or operatively. In some examples, communication channels 244 may include a system bus, a network connection, an inter-process communication data structure, or any other method for communicating data.

One or more processors 222 may implement functionality and/or execute instructions within the outlier detection system 100. For example, processors 222 may be configured to receive instructions and/or data from storage devices 230 to execute the functionality of the modules shown in FIG. 2, among others (e.g. operating system, applications, etc.) and to run the operating system of the operating system module 234.

Outlier detection system 100 may store data/information including current, historical and dynamically received input data (e.g. account data 112, current account data 115, customer outliers 110, segmentation trees 111, output rules 310, cluster set 312, first decision tree 311, etc. as generated by the environment 150 and/or or outlier detection system 100) to storage devices 230. Some of the functionality is described further herein below.

One or more communication units 226 may communicate with external computing devices, such as customer computing devices and/or transaction processing servers and/or account repositories, etc. (not shown) via one or more networks by transmitting and/or receiving network signals on the one or more networks. The communication units 226 may include various antennae and/or network interface cards, etc. for wireless and/or wired communications.

Input devices 224 and output devices 228 may include any of one or more buttons, switches, pointing devices, cameras, a keyboard, a microphone, one or more sensors (e.g. biometric, etc.) a speaker, a bell, one or more lights, etc. One or more of same may be coupled via a universal serial bus (USB) or other communication channel (e.g. 244).

The one or more storage devices 230 may store instructions and/or data for processing during operation of the outlier detection system 100. The one or more storage devices 230 may take different forms and/or configurations, for example, as short-term memory or long-term memory. Storage devices 230 may be configured for short-term storage of information as volatile memory, which does not retain stored contents when power is removed. Volatile memory examples include random access memory (RAM), dynamic random access memory (DRAM), static random access memory (SRAM), etc. Storage devices 230, in some examples, also include one or more computer-readable storage media, for example, to store larger amounts of information than volatile memory and/or to store such information for long term, retaining information when power is removed. Non-volatile memory examples include magnetic hard discs, optical discs, floppy discs, flash memories, or forms of electrically programmable memory (EPROM) or electrically erasable and programmable (EEPROM) memory.

In at least some aspects, outlier module 104 may be configured to receive input data such as account data 112, along with an input query relating to proactive anomaly prediction for a particular feature of interest based on historical patterns of anomalies in customer account data. Such data may be retrieved by the outlier module from the account data repository 236 storing current and historical account data along with other metadata for use by the machine learning models of the system 100. The outlier module 104 may generally utilize a clustering module 113 (e.g. a customized HDBSCAN) to cluster the input data (e.g. application data and credit data) with other similar data based on similarity of features in the data. This clustering information is fed to the anomaly module 114 to label the data within each clustered group based on constructing a probability distribution of the data for each cluster (for the feature for which anomaly is being detected), and apply a dynamically generated threshold to each cluster to flag anomaly data (e.g. anomaly income data based on the threshold for the cluster) and thereby apply labelling based on the anomaly prediction likelihood (e.g. to generate the labelled data sets 105 of FIG. 1).

In at least some aspects, current and historical labelled data sets 105 may be stored in the labelled data repository 240 for subsequent access by the outlier detection system 100 and review such as via the graphical user interface 232.

The outlier module 104 may cooperate with the graphical user interface 232 such as to provide output graphs of the distributions for each cluster (e.g. see FIG. 3B) and allow user customizable threshold values for the clusters such as to customize the percentile anomaly thresholds for each of the clusters and to review the features processed by the clustering module 113 on a display as shown in FIG. 3B, for example.

The rule extraction module 106 may be configured to receive an input of labelled data sets 105 along with additional training data for the tree model 116 (e.g. a light gradient boosted model) which implements a supervised machine learning model. That is, the rule extraction module 106 may be configured to extract additional features of interest from the input data for each of the accounts to train the tree model 116. Notably, the tree model 116 once trained may be configured to produce a decision tree (see example FIG. 3A of the first decision tree 311) such that the end node of the tree indicates which information data paths lead to a likely indication of anomaly and which do not. In this way, the rule extraction module 106 is configured to extract computing model rules from the tree model 116 once trained to generate a set of executable rules which may be stored in the rules executable 238 for subsequent anomaly detection and explanation.

The examples above are not meant to be limiting.

In some aspects, the outlier detection system 100 may contain pre-defined and/or pre-determined specifics on processing and/or resource capability of the system 100 and thus be configured to have a threshold of the number of computing rules which may be generated or the number of features considered in the decision tree, and/or the number of clusters which the clustering module 113 forms, and/or the amount of historical anomaly information which the system stores.

It is understood that operations described herein may not fall exactly within the modules of FIG. 2 as illustrated such that one module may assist with the functionality of another and that in at least some aspects, the functionality of the outlier detection system 100 may be provided by a plurality of computing devices networked together to provide the functionality described herein.

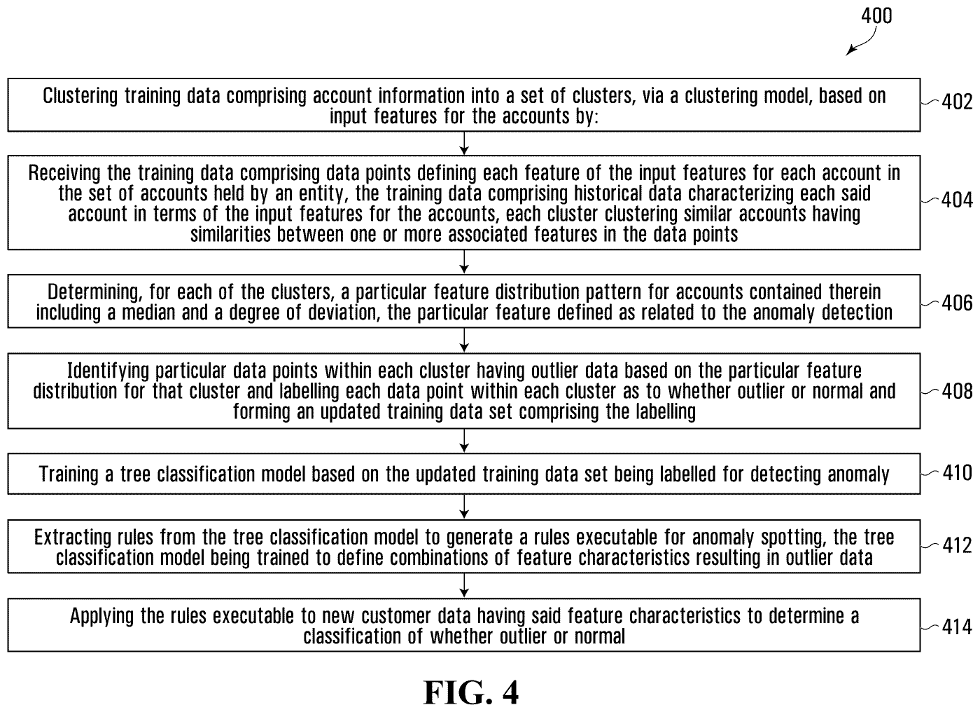

Referring to FIG. 4, shown is an example process 400 and flowchart of operations, which may be performed by a computing device such as the outlier detection system 100 of FIGS. 1 and 2, according to one embodiment. To begin the process, the outlier module 104 may receive unlabeled data having a number of attributes or features related to the anomaly detection, such as but not limited to, account application data for a set of applicants and associated transaction data for an entity for generating the labels for each of the received data points and associated customer accounts. An input to the outlier detection system 100 may include a query request (e.g. received from one or more connected computing devices such as application processing data servers) for proactively detecting, flagging and providing explainability of such anomaly detection.

The computing device may comprise a processor configured to communicate with a display to provide a graphical user interface, (e.g. for displaying the clustering shown in FIG. 3A, the output rules 310 in FIG. 3A the distribution of feature values in clusters in FIG. 3B, the raw and extracted rule sets in FIGS. 3C and 3D) where the computing device has an input to receive input interacting with the GUI (e.g. to view or update the anomaly thresholds in FIG. 3B) and wherein instructions stored in a non-transient storage device when executed by the processor, configure the computing device to perform operations such as the process 400.

In the example of FIG. 4, at a first operation step 402, the input data provided to the outlier module 104 which includes account information (e.g. historical account data 112 comprising customer accounts and associated feature metadata) is utilized as training data and applied to the outlier module 104. The outlier module 104 is configured to cluster the input data received, e.g. the training data, into a set of clusters via a clustering model, e.g. clustering module 113. An example of such clustering is shown in FIG. 3A at step 301 which depicts the example cluster set 312 containing three different clusters based on a similarity distance measurement and determination. Such clustering may group together input data relating to customers having similar behaviors and patterns as identified in the input data.

The clustering performed at the first operation step 402 may be performed by the further detailed second operation step 404 which comprises receiving the training data (e.g. account data 112) comprising data points defining each feature of the input features (e.g. income data, credit attributes, customer profile data, etc.) for each account in the set of accounts held by an entity, the training data comprising historical data characterizing each said account in terms of the input features for the accounts, each cluster (e.g. first cluster 304, second cluster 306, third cluster 308 in cluster set 312) clustering similar accounts having similarities between one or more associated features in the data points. As noted earlier, in at least some aspects, the clustering module 113 applies unsupervised clustering technique such as density based clustering (E.g. HDBSCAN) whereby the clustering module 113 is configured to automatically determine the optimal number of clusters based on a defined threshold distance between feature values in the data points which is defined as acceptable distance to assign as within a same cluster.

At a third operation step 406, operations of the computing device, e.g. outlier detection system 100, are configured to determine, for each of the clusters as generated by the clustering module 113 (e.g. cluster set 312 in FIG. 3A), a distribution pattern (e.g. probability distribution function) for a particular feature of interest for accounts contained therein including a median and a degree of deviation for the distribution pattern (e.g. from the median to the farthest point on the x-axis for which a data point exists for that cluster). The particular feature may be defined as related to the anomaly detection or may be received such as from another computing device along with a query for anomaly prediction and detection. An example of such a distribution is shown at FIG. 3B whereby an income distribution graph is determined for each cluster using a set of attribute descriptors shown as persona descriptors 1-5 in FIG. 3B. Referring to FIG. 3B, a set of anomaly threshold values 332 may be applied to each respective cluster based on the distribution curve. For example, in FIG. 3B, the x-axis may depict the value of the feature of interest for anomaly detection (e.g. income data) and the y-axis may depict the probability density of that feature for a particular cluster.

At a fourth operation step 408, operations of the computing device, e.g. outlier detection system 100, are configured to identify particular data points within each cluster having outlier data based on the particular feature distribution for that cluster and labelling each data point within each cluster as to whether outlier or normal and forming an updated training data set comprising the labelling. In the example of FIG. 3B, it may be defined that the anomaly threshold is at a given percentile value (e.g. percentile anomaly threshold) and a set of respective anomaly thresholds 332 determined therefrom. Alternatively, in some aspects, outlier data may be determined by the outlier detection system 100 determining a standard deviation from the mean of the distribution exceeds a predetermined value for that given cluster and thereby indicative of anomaly data.

An example of such outlier labelled data points is shown at FIG. 3A, with the first abnormal data point 304a, the second abnormal data point 306a and the third abnormal data point 308a from each of the three clusters formed in the cluster set 312. Additional outlier data points may be envisaged depending on an anomaly threshold set for the distribution for each cluster. Generally, in at least some aspects, outliers within a data set are data points which are far away from the other data points based on the distribution function constructed. As shown in FIG. 3B, the anomaly percentile thresholds 332 may be defined such that outlier data points at or above the anomaly percentile threshold for the particular cluster may be labelled as anomaly data points within the metadata defining the anomaly or normal feature characteristics for the feature of interest. As shown in FIG. 3B, each cluster may be assigned its specific percentile anomaly threshold value (anomaly threshold values 332 for each of the clusters) depending on and specific to the distribution curve function constructed for that cluster.

An example of the updated training data set depicted in operation step 408 comprising the labelling of anomaly or not segmentation metadata is shown as the labelled data sets 105 in FIGS. 1 and 3A.

At a fifth operation step 410, operations of the outlier detection system 100 train a single tree classification model such as the tree model 116 on the labelled data set from operation step 408 provided as the updated training data (e.g. labeled data sets 105). The trained model is trained for detecting anomalies in the data, an example of such a generated tree model is shown at step 302 in FIG. 3A depicting end nodes of the decision tree as being normal or anomaly nodes. As noted earlier, the tree model is trained such that rules may be extracted therefrom for anomaly detection. In at least some aspects, the decision tree implemented in the tree model 116 is a light gradient boosted machine learning model.

Following step 410, at a sixth operation step 412, operations of the outlier detection system 100 are configured, via the rule extraction module 106 as shown in FIGS. 1, 2 and 3A to extract classification model rules from the tree model 116, once trained. In one aspect, the training may occur via the labelled data sets 105 and/or the historical features of the training data (e.g. as extracted from account data 112 such as via the historical profile data 103). As mentioned earlier, FIGS. 3C and 3D illustrate examples of such extracted rules in raw format and in the formatted extracted rules format of FIG. 3D. Notably, at step 412, the outlier detection system 100 is configured to generate a rules executable based on the extracted rules (e.g. rules shown in FIG. 3D) for anomaly spotting (e.g. as shown in FIG. 3D, under certain feature conditions, a tree node indicating anomaly or normal probability is reached). The rules executable generated is further based on the tree model 116 being trained to define combinations of feature characteristics resulting in outlier data such as that shown in the first decision tree 311 and may be converted into the rules executable set for execution thereof by the outlier detection system 100 for subsequent anomaly detection in unseen or new data at operation step 414. That is, the outlier detection system 100 is configured to apply the rules executable to new customer data containing new account information with one or more of the features or attributes defined by the outlier system 100 and specifically, the tree model 116 (e.g. new customer data containing features including but not limited to: mortgage, capacity, debt history as shown at step 302 in the example first decision tree 311 for detection of normal or anomaly segmentation). Conveniently, in at least some implementations, the combination of the supervised and unsupervised models (e.g. as shown in FIG. 1) as provided in the present disclosure allows an input of unlabeled data and eventually ending up with a set of understandable and deployable executable rules for implementation on a computing system such as the outlier detection system 100 in the environment 150 thereby leveraging benefits of models in the clustering and decision tree models to allow labelling of data via clustering and rule extraction via the decision tree model to provide, in at least some aspects, an optimized machine learning model for anomaly detection and deployment.

It is contemplated that any part of any aspect or embodiment discussed in this specification can be implemented or combined with any part of any other aspect or embodiment discussed in this specification.

It should be recognized that features and aspects of the various examples provided above can be combined into further examples that also fall within the scope of the present disclosure. In addition, the figures are not to scale and may have size and shape exaggerated for illustrative purposes.

One or more currently preferred embodiments have been described by way of example. It will be apparent to persons skilled in the art that a number of variations and modifications can be made without departing from the scope as defined in the claims.

What is claimed is:

1. A computerized machine learning system for detecting anomalies in account data, comprising:
an unsupervised clustering module configured to receive unlabeled account data sets comprising data points with corresponding feature values for defined input features as training data, the clustering module clustering the account data sets into a set of clusters based on similarities between the feature values for the input features within each cluster being more than across other clusters;
an anomaly detection module coupled to the unsupervised clustering module configured to: receive the set of clusters and corresponding account data sets contained within each of the clusters; determine, for each of the clusters, a distribution pattern of the feature values in the account data sets, corresponding to a plurality of accounts, for a particular feature defined as being associated with detecting anomalies and based on the distribution pattern, determine a percentile threshold value above which anomalies occur for the particular feature and label the data points in each of the account data sets for each cluster having the feature values for the particular feature exceeding the percentile threshold value with anomaly metadata indicative of anomaly and others as normal to generate labelled data sets with the anomaly metadata; and
a single tree classification model coupled to the anomaly detection module for receiving the labelled data sets and mapping the feature values for the input features in the account data sets onto the tree classification model and extracting a set of rules from the tree classification model for generating a rules executable for subsequent classification of anomaly, the rules comprising a set of different combinations of identified features from the input features and corresponding value ranges associated with a likelihood of anomaly for the particular feature.

2. The system of claim 1, wherein the single tree classification model is configured to classify new customer data having the input features and apply the set of rules to the feature values of the new customer data to determine a classification of whether the new customer data is outlier income or normal and sending the classification to a graphical user interface for display thereof.

3. The system of claim 2, wherein subsequent to the clustering forming the clusters, the anomaly detection module is configured for labelling each abnormal high normal account in a given cluster with a binary value 1 and labelling each normal account with a different binary value 0 for being fed into the single tree classification model as the labelled data sets for subsequent rule extraction thereof.

4. The system of claim 3, wherein the tree classification model is a light gradient boosted model.

5. The system of claim 2, wherein identifying particular data points having outlier incomes in each cluster comprises, determining from the distribution pattern for each said cluster, a deviation amount from a median of the distribution pattern which corresponds to a defined percentile occurrence of the particular feature for the account data sets, determining that particular data points having a degree of deviation exceeding the deviation amount thereby indicating anomaly as compared to other data points within that cluster.

6. The system of claim 2, wherein mapping the feature values onto the tree classification model further comprises grouping the feature values for the input features into broader category of features based on commonalities between the input features and the extracted set of rules generated as having the broader category of features and associated value ranges for categorization into the likelihood of anomaly.

7. The system of claim 6, wherein the defined input features is selected from the group: debt history, mortgage amounts, mortgage payments, utilization ratio and credit limits associated with accounts of one or more customers.

8. The system of claim 7, wherein the tree classification model receives historical customer data and current customer data for the account data sets relating to the broader category of features comprising: mortgage attributes, debt history, and financial capacity of one or more customers for generating the tree classification model.

9. The system of claim 8, wherein the single tree classification model is configured to extract the set of rules by: utilizing the historical customer data and the current customer data applied to the single tree classification model to identify features and segmentation parameters for the value ranges associated with a likelihood of anomaly.

10. The system of claim 6, wherein the single tree classification model is applied to an output of the anomaly detection module comprising the labelled data sets for characterizing the rules for generating the labelled data sets based on a second set of features comprising the broader category of features for the labelled data sets, the second set of features extracted by the single tree classification model having been trained on historical customer data as related to the particular feature.

11. A computerized method of using machine learning models for anomaly detection in a set of accounts, the method comprising:
clustering training data comprising account information into a set of clusters, via a clustering model, based on input features for the accounts by:
receiving the training data comprising data points defining each feature of the input features for each account in the set of accounts held by an entity, the training data comprising historical data characterizing each said account in terms of the input features for the accounts, each cluster clustering similar accounts having similarities between one or more associated features in the data points;
determining, for each of the clusters, a particular feature distribution pattern for accounts contained therein including a median and a degree of deviation, the particular feature defined as related to the anomaly detection;
identifying particular data points within each cluster having outlier data based on the particular feature distribution for that cluster and labelling each data point within each cluster as to whether outlier or normal and forming an updated training data set comprising the labelling;
training a tree classification model based on the updated training data set being labelled for detecting anomaly;
extracting rules from the tree classification model to generate a rules executable for anomaly spotting, the tree classification model being trained to define combinations of feature characteristics resulting in outlier data; and, applying the rules executable to new customer data having said feature characteristics to determine a classification of whether outlier or normal.

12. The method of claim 11, wherein identifying the particular data points having outlier incomes in each cluster comprises, receiving a defined deviation threshold for each said cluster and determining that the particular data points in that cluster have a particular degree of deviation exceeding the defined deviation threshold thereby indicative of anomaly as compared to other data points within that cluster.

13. The method of claim 12, wherein subsequent to the clustering forming the cluster, the labelling further comprising: labelling each abnormal high normal account in a given cluster with a binary value 1 and labelling each normal account with a different binary value 0 for being fed into the tree classification model.

14. The method of claim 13, wherein the tree classification model is a supervised model and the clustering model is an unsupervised model structurally linked to extract the rules therefrom.

15. The method of claim 14, wherein the tree classification model is a light gradient boosted model.

16. The method of claim 13, wherein the data points define features comprising: self-reported income and earnings; customer credit attributes data, and customer profile data comprising historical spending patterns and behaviours.

17. The method of claim 16, wherein the customer credit attributes data comprises debt history, mortgage amounts, mortgage payments, and mortgage credit limits of one or more customers.

18. The method of claim 12, wherein extracting rules from the tree classification model further comprises: utilizing historical customer data and current customer data applied to the tree classification model to identify feature variables and segmentation parameters associated with a likelihood of anomaly.

19. The method of claim 18, wherein the historical customer data and current customer data is characterized by defining: mortgage attributes, debt history, and financial capacity of one or more customers for generating the tree classification model.

20. The method of claim 16, further comprising applying the labelled data sets to the tree classification model for characterizing the rules for generating the labelled data sets based on a second set of features defining a tree structure for the tree classification model, the second set of features extracted by the single tree classification model having been trained on historical customer data as related to the particular feature.

21. A computer program product comprising a non-transient storage device storing instructions that when executed by at least one processor of a computing device, configure the computing device for using machine learning models for anomaly detection in a set of accounts, the instructions executable by the at least one processor to perform the steps of:
clustering training data comprising account information into a set of clusters, via a clustering model, based on input features for the accounts by:
receiving the training data comprising data points defining each feature of the input features for each account in the set of accounts held by an entity, the training data comprising historical data characterizing each said account in terms of the input features for the accounts, each cluster clustering similar accounts having similarities between one or more associated features in the data points;
determining, for each of the clusters, a particular feature distribution pattern for accounts contained therein including a median and a degree of deviation, the particular feature defined as related to the anomaly detection;
identifying particular data points within each cluster having outlier data based on the particular feature distribution for that cluster and labelling each data point within each cluster as to whether outlier or normal and forming an updated training data set comprising the labelling;
training a tree classification model based on the updated training data set being labelled for detecting anomaly;
extracting rules from the tree classification model to generate a rules executable for anomaly spotting, the tree classification model being trained to define combinations of feature characteristics resulting in outlier data; and, applying the rules executable to new customer data having said feature characteristics to determine a classification of whether outlier or normal.
